(19) United States
(12) Patent Application Publication
(10) Pub. No.: US 2012/0056424 A1
(43) Pub. Date: Mar. 8, 2012

(54) METHOD AND DEVICE FOR DECELERATING AN UNDERWATER POWER STATION

(76) Inventors: Benjamin Holstein, Heidenheim (DE); Norman Perner, Neu-Ulm (DE); Michael Holle, Sohnstetten (DE); Klaus Kruger, Huttlingen (DE)

(21) Appl. No.: 13/138,508

(22) PCT Filed: Feb. 25, 2010
(86) PCT No.: PCT/EP2010/001156

§ 371 Date: Nov. 14, 2011

(30) Foreign Application Priority Data
Mar. 9, 2009 (DE) 10 2009 011 784.9

(51) Int. Cl. H02P 9/04

(52) U.S. Cl. 290/43

(57) ABSTRACT

The invention concerns a method for the operation of an underwater powerplant comprising a water turbine for purposes of absorbing kinetic energy from a flow of water; an electrical generator with converter feed, whose generator rotor is connected in a torsionally rigid manner with the water turbine, wherein the invention is characterised in that in normal operation a first frequency converter is used for purposes of converter feed, and in the braking operation at least one second frequency converter, or one component of a second frequency converter, is connected into the circuit and synchronised with the first frequency converter, in order to execute with the latter in a combined manner a converter feed to the electrical generator, which generates a generator torque braking the water turbine.

The present invention concerns a method and a device for purposes of braking an underwater powerplant, in particular a tidal powerplant.

Underwater powerplants, free-standing and without dam structures, which extract kinetic energy from a flow of water and serve to generate electricity, can be sited in a body of flowing water, or at a suitable location in the sea. The latter type serve to extract energy either from a continuous sea current, or from a cyclically changing tidal flow. One possible form of embodiment of such a powerplant comprises a water turbine designed in the form of a propeller, which is installed with its rotor horizontal. The water turbine drives an electrical generator, which is accommodated in a machinery nacelle, which is attached to a supporting structure that is either buoyant, or is built on foundations on the bed of the body of water.

As a result of the difficult access to immersed underwater powerplants of this generic kind, their components must be designed to be as maintenance-free as possible. Amongst other components, this relates to the braking system used to shut down the water turbine. If a hydraulic-mechanical form of brake, and in particular a disc brake, is used for this purpose, a number of difficulties ensue in its design. On the one hand, by reason of the guidelines described above regarding the stability of the powerplant, and in order to circumvent the problems of leaking lubrication media, the application of geared transmissions in the drive train is dispensed with. From this it follows that during the braking process a disc brake connected with a slowly rotating unit must absorb the whole of the torque generated by the water turbine. This difficulty is compounded by the fact that for such a brake an area must be created that is sealed against the external environment in order to circumvent the problems of corrosion and encrustation for a braking system that is typically used non-continuously. For this reason exacting design requirements ensue for any hydraulic-mechanical braking system that is suitable for an underwater powerplant, so that in order to improve the operational reliability in many cases a further braking system is provided that is only used in emergency situations. In this regard, reference is made to the example of GB 2441822 A. However, such systems are typically installed such that the restoration of normal operation after such an emergency braking system has been triggered is impossible without further work.

In addition, a blade angle adjustment mechanism can be used for purposes of braking the water turbine; in normal operation this serves to limit the power generated by the water turbine when the nominal power rating has been reached. For purposes of braking the blade angle is set such that effective braking is possible via alteration of the turbine's operating characteristics. A disadvantage of this braking method is the work required to design and construct a blade angle adjustment system. Moreover, with such a mechanism an additional risk of failure is introduced into the powerplant. In the event of an incorrect blade setting with high incident flow loadings there is the risk of loss of a turbine blade. In addition a blade angle adjustment mechanism, by reason of the movable parts used, presupposes regular maintenance, which is usually only possible within the context of a service executed above water level.

The object of the invention is therefore to specify a method and a device that is suitable for the method, which are suitable for purposes of braking and halting an underwater powerplant, and in particular can be used for an energy park with a multiplicity of underwater powerplants. Furthermore, the device used for the execution of the braking method should be distinguished in terms of simplicity of design and a high level of operational reliability.

The object underlying the invention is achieved by means of the features of the independent claims. Advantageous embodiments ensue from the dependent claims. The ancillary torque generated by the electrical generator is used to execute the inventive braking method for an underwater powerplant. Here the assumed starting point is a powerplant configuration with a torsionally rigid connection between the generator rotor of the electrical generator and the water turbine. The use of a directly driven electrical generator is conceivable, as is the arrangement of a step-up gearbox in the drive train between the water turbine and the generator rotor, wherein it must be ensured that a braking torque applied by the electrical generator is transferred to the water turbine.

A braking method based on the ancillary torque of the electrical generator can be executed with either a synchronous generator, or an asynchronous generator, insofar as the latter features converter feed. Here the frequency converter used for converter feed must satisfy the power requirements during the braking operation. In order to be able to avoid over-dimensioning of the frequency converters used, the converter feed to the electrical generator is inventively designed for normal operation, and during braking operations one or a plurality of additional frequency converters, or their generator-side components, that is to say, generator-side rectifiers, are connected into the circuit. In what follows the term “second frequency converter” is used in this respect; the second frequency converter is synchronised with the first frequency converter, which undertakes the converter feed during normal operation, and after having been connected into the circuit executes a converter feed in combination with the first frequency converter to the electrical generator, which generates a generator torque that brakes the water turbine.

The concept of a second frequency converter, which is only connected into the circuit during braking operations, is particularly advantageous in the case in which a plurality of underwater powerplants are grouped to form an energy park, since one or a plurality of the frequency converters of the underwater powerplants that are not to be braked can be called upon as a second frequency converter. As a consequence the converter feeds and thus the generator ancillary torques for these powerplants cease to exist, so that their water turbines accelerate. Advantageously for this reason the underwater powerplants of the energy park are designed to operate reliably at high running speeds up to the runaway rotational speed of the water turbines. In this case an underwater powerplant called upon for the braking of another underwater powerplant can run without damage in no-load operation at a high running speed, while its frequency converter, as a second frequency converter, supports the first frequency converter of the underwater powerplant to be braked in its execution of the braking operation.

For an advantageous embodiment the water turbine of the underwater powerplant is configured such that when the nominal power rating has been reached power limitation is not effected by a blade angle adjustment mechanism, or by flow separation on the turbine blades. Instead the operating point is displaced into the high running speed regime above the optimum power rotational speed. This can be effected either by management of the rotational speed, or by specification of an electrical generator torque. However, when stopping the powerplant the problem arises that in the course of braking the water turbine the latter must run through the maximum power region. With the inventive method there is no need to design the frequency converter with an appropriate power reserve for this purpose. Instead, the latter is matched to normal operation, that is to say, to the powerplant's nominal power rating. By connecting the second or further frequency converters into the circuit with the first frequency converter, the higher power generated is safely absorbed when passing through the maximum power regime during the braking operation.

In accordance with an alternative embodiment the second frequency converter is a component that is exclusively deployed during braking operations. In the case of an individual powerplant this second frequency converter represents a component that provides redundancy during normal operation, and in the event of a fault can replace the first frequency converter, at least for a short period of time, since the braking operation in many cases represents an activity that can be planned for and executed at longer time intervals.

A particular advantage of an additional frequency converter that is only used for the braking operation exists in the case when a plurality of underwater powerplants are grouped to form an energy park, wherein advantageously an option is created of connecting the second frequency converter with any of the individual plants of the energy park as required. Furthermore, with an appropriate design of the second frequency converter it is conceivable that more than one underwater powerplant of the energy park can be braked at the same time. For an economic configuration, however, the second frequency converter that is connected into the circuit for braking purposes is designed for the power reserve that is additionally necessary for purposes of braking an individual powerplant.

In what follows the invention is elucidated in an exemplary manner with the aid of examples of embodiment, and in conjunction with figures that represent the following:

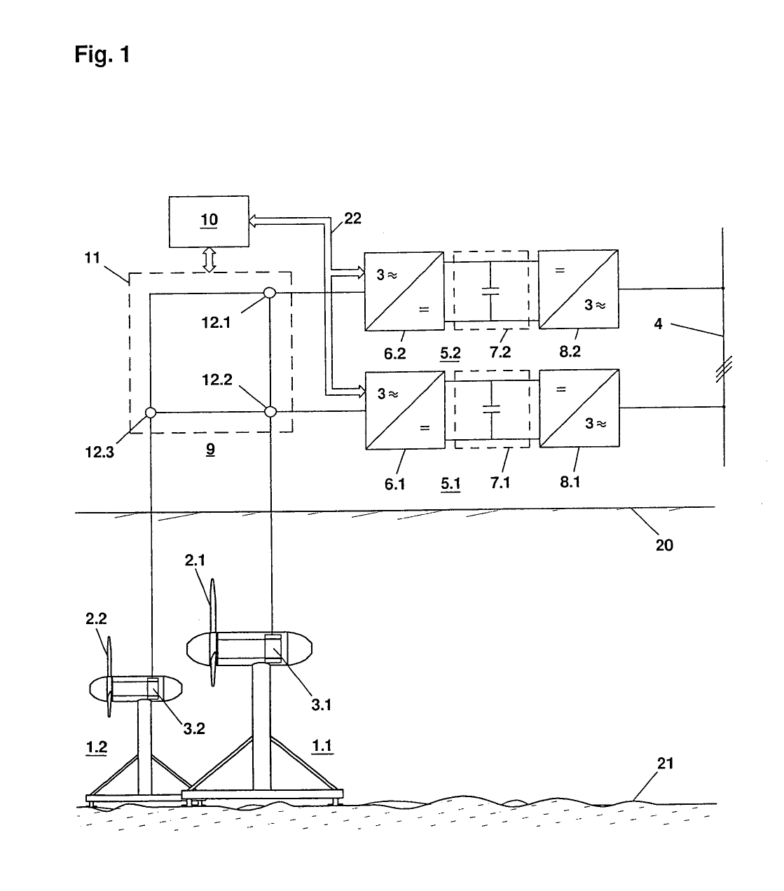

FIG. 1 shows a first embodiment of the invention for two underwater powerplants of an energy park with frequency converters that can be connected together.

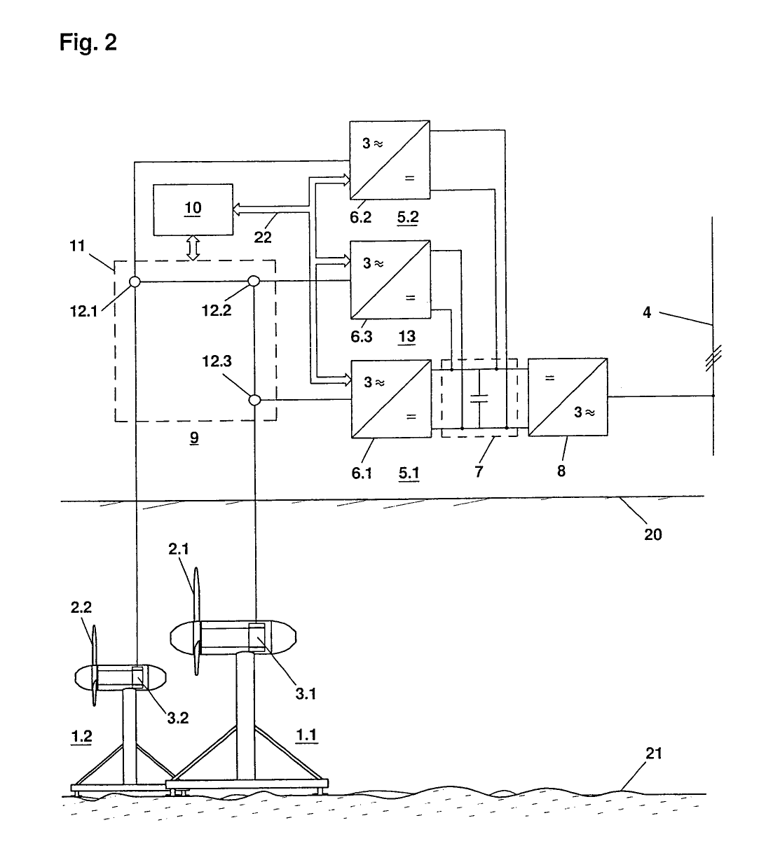

FIG. 2 shows an alternative embodiment with a separate frequency converter, which can be connected into the circuit for the braking operation.

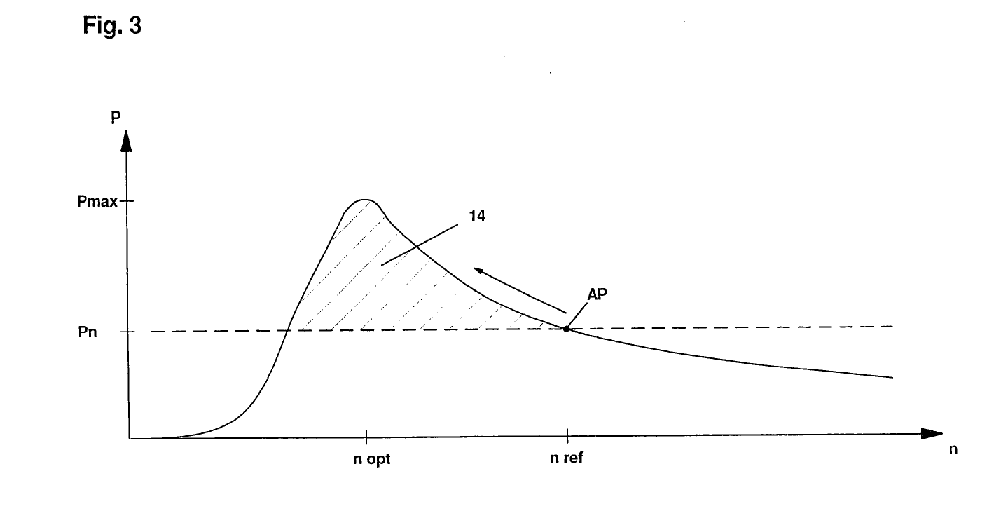

FIG. 3 shows for a water turbine, whose power output is limited at high running speeds, the power absorbed during braking.

FIG. 1 represents two underwater powerplants 1.1, 1.2 of an energy park in a schematically simplified manner. These are designed as free-standing units, located completely under the water level 20 and built on foundations on the bed 21 of the body of water. Each of the underwater powerplants 1.1, 1.2 comprises a water turbine 2.1, 2.2, which is connected in a torsionally rigid manner with the generator rotor of an associated electrical generator 3.1, 3.2. Here synchronous generators are particularly likely to find application; these are connected by means of a frequency converter 5.1, 5.2 to an integrated network 4 for purposes of variable rotational speed operation. Alternatively, doubly-fed asynchronous generators are used; these can be operated at rotational speeds above or below the synchronous rotational speed of the integrated network 4.

In the present embodiment the frequency converters 5.1, 5.2 in each case comprise a generator-side rectifier 6.1, 6.2, an intermediate DC circuit 7.1, 7.2, and a network-side inverter 8.1, 8.2. In normal operation the frequency converter 5.1 is used to provide a converter feed to the electrical generator 3.1 of the underwater powerplant 1.1. In accordance with the terminology presently being used it represents the first frequency converter for the underwater powerplant 1.1. Correspondingly, the frequency converter 5.2 is the first frequency converter for the underwater powerplant 1.2, and is thus used in the normal operation of the latter.

With the aid of FIG. 3 it can be seen that for an underwater powerplant that is power limited at high running speeds, a turbine power P in excess of the nominal power Pn (represented as a hatched area) is absorbed during braking of the water turbine 2.1, 2.2. Here it is assumed that the design concept for the powerplant does not provide the water turbine with a blade angle adjustment mechanism. For purposes of power limitation the water turbine is managed by the specification of a rotational speed or torque to a working point AP, whose associated design rotational speed nref lies above the optimum power rotational speed n0. The desired limitation to the nominal power Pn is effected with a power characteristic that levels out in the high running speed regime. For power limitation of the underwater powerplant 1.1, 1.2 selected in such a manner the first frequency converter in accordance with the invention is dimensioned for normal operation in terms of the nominal power rating Pn. The excess power that arises during braking in the regime of the power maximum Pmax is absorbed by the inventively provided connection into the circuit of a second frequency converter. For the embodiment in accordance with FIG. 1 the coupling device 9 serves to provide this connection into the circuit. This comprises a switching unit 11, which is designed in the form of a distribution box as a matrix of power switches 12.1, 12.2, 12.3 and comprises, for example, electronic high-power switches (thyristors, triacs) or mechanical power circuit interrupters. In addition, a control unit 10 is assigned to the coupling device 9; this serves to actuate the switching processes in the switching unit 11, and before switching to synchronise the second frequency converter provided for braking purposes with the electrical generator 3.1, 3.2 to be braked. For this purpose in FIG. 1 data lines 22 are sketched in between the control unit 10 and the frequency converters 5.1, 5.2.

For the case in which the underwater powerplant 1.1 is to be braked, in addition to the first frequency converter 5.1, the frequency converter 5.2 of the underwater powerplant 1.2 is introduced as a second frequency converter for this powerplant. Here for the second underwater powerplant 1.2, which is not to be braked, the converter feed and thus the ancillary torque of the electrical generator 3.2 cease to exist. As a consequence the water turbine 2.2 will accelerate up to its runaway rotational speed. During the braking operation a coupling of the frequency converters 5.1, 5.2 is conducted after synchronisation via the power switches, 12.1, 12.2, and a generator torque is generated that brakes the water turbine 2.1 to a halt. The other underwater powerplant 1.2 can then be managed back to its working point AP, in that the resynchronised frequency converter 5.2 is connected into the circuit via the power switches 12.1, 12.2.

FIG. 2 shows an alternative embodiment of the invention with a separate frequency converter 13, which is used exclusively as a power reserve for braking operations. A further modification compared with the embodiment in accordance with FIG. 1 is represented by the grouping of the generator-side converters 6.1, 6.2, 6.3 by means of a common intermediate DC circuit 7 and a common network-side inverter 8, which, at least indirectly, is connected into the integrated network 4. As a consequence the frequency converters 5.1, 5.2, 13 have components in common, wherein the generator-side rectifiers 6.1, 6.2, 6.3 are either assigned for normal operation to a particular underwater powerplant, or belong to the separate frequency converter that serves the braking operation. In the context of the terminology that is presently being used the generator-side rectifiers 6.1, 6.2, 6.3 are designated as second generator-side rectifiers, if for purposes of executing a braking procedure in accordance with the connections they are synchronised with an electrical generator 3.1, 3.2, and in addition are connected into the circuit of the latter, for whose converter feed they are not provided in normal operation.

With reference to the arrangement of the frequency converters 5.1, 5.2, 13 various configurations can be conceived. In a first example of embodiment these are arranged in a dry location, for example on a platform, in close proximity to the underwater powerplants 1.1, 1.2 above the water level 20. Alternatively a land-based site can be provided. In other forms of embodiment the frequency converters 5.1, 5.2, 13 are installed in a decentralised manner. Here, for example, the generator-side rectifiers 6.1, 6.2, 6.3 can be accommodated near the powerplant in the machinery nacelle of the underwater powerplant 1.1, 1.2, while the other components, the intermediate DC circuit 7, 7.1, 7.2 and also the network-side inverters 8, 8.1, 8.2 are arranged above the water level 20 and, particularly preferably, in a service station on land.

In a further configuration of the invention the second frequency converter, or its components provided for purposes of connecting into the circuit, in particular the second generator-side rectifier, are additionally introduced for purposes of braking for optimisation of the power output of an energy park. In particular when using a redundant, separate frequency converter 13 the latter can be connected into the circuit during normal operation, if there is a risk of overload for a first frequency converter 5.1, 5.2. Furthermore it is conceivable for the first frequency converter to be driven for a brief period of time in the overload regime for purposes of energy optimisation, and for a redundant, separate frequency converter 13 to be connected into the circuit for a predetermined time period in each case in order to avoid overheating of the first frequency converter. If the operating temperature of the first frequency converter, when thus supported, falls below a design value, the second, separate frequency converter 13 can be decoupled and connected with another powerplant in the energy park. In addition a second, separate frequency converter 13 can be connected into the circuit, if during operation of the generator for the start-up of a powerplant a high power reserve is necessary for the frequency converter.

Furthermore, configurations within the framework of the following protective claims are conceivable, in which during braking a separate frequency converter 13, and one or a plurality of first frequency converters, in addition serve other underwater powerplants in combination. Moreover the inventive method can be combined with additional braking methods of known art. In addition an additional hydraulic-mechanical brake can be used as an emergency system, or to secure a powerplant in the stationary state,

### REFERENCE SYMBOL LIST

1.1, 1.2 Underwater powerplant

2.1, 2.2 Water turbine

3.1, 3.2 Electrical generator

4 Integrated network

5.1, 5.2 Frequency converter

6.1, 6.2, 63 Generator-side rectifier

7, 7.1, 7.2 Intermediate DC circuit

8.1, 8.2 Network-side inverter

9 Coupling device

10 Control unit

11 Switching unit

12.1, 12.2

12.3 Power switch

13 Separate frequency converter

14 Excess power

20 Water level

21 Bed of the body of water

22 Data lines

n Rotational speed

nopt Optimum power rotational speed

n ref Design rotational speed

P Turbine power

Pn Nominal power rating

Pmax Maximum power

1.-9. (canceled)

10. A method for the operation of an underwater powerplant, comprising:
a water turbine for purposes of absorbing kinetic energy from a flow of water,
an electrical generator with converter feed, whose generator rotor is connected in a torsionally rigid manner with the water turbine, characterised in that
in normal operation, a first frequency converter is used for purposes of converter feed, and in that in the braking operation at least one second frequency converter, or one component of a second frequency converter, is connected into the circuit and synchronised with the first frequency converter, in order to execute in a combined manner with the latter a converter feed of the electrical generator, which generates a generator torque that brakes the water turbine.

11. The method in accordance with claim 10, characterised in that in normal operation the water turbine, when it has reached the nominal load Pn, for purposes of power limitation is brought into a rotational speed regime that lies above the optimum power rotational speed n0.

12. The method in accordance with claim 11, characterised in that the overall system of the second frequency converter that is connected into the circuit, or the components of the second frequency converter that are connected into the circuit, during the braking operation, is dimensioned such that the specified performance of the electrical generator complies with the converter feed at the optimum power rotational speed.

13. The method in accordance with claim 10, characterised in that the underwater powerplant is part of an energy park with a multiplicity of underwater powerplants, wherein the second frequency converter that is connected into the circuit, or the component of a second frequency converter that is connected into the circuit, during the braking operation, in normal operation serves to provide the converter feed for another underwater powerplant.

14. The method in accordance with claim 11, characterised in that the underwater powerplant is part of an energy park with a multiplicity of underwater powerplants, wherein the second frequency converter that is connected into the circuit, or the component of a second frequency converter that is connected into the circuit, during the braking operation, in normal operation serves to provide the converter feed for another underwater powerplant.

15. The method in accordance with claim 12, characterised in that the underwater powerplant is part of an energy park with a multiplicity of underwater powerplants, wherein the second frequency converter that is connected into the circuit, or the component of a second frequency converter that is connected into the circuit, during the braking operation, in normal operation serves to provide the converter feed for another underwater powerplant.

16. The method in accordance with claim 13, characterised in that for those underwater powerplants, which provide a second frequency converter, or a component of a second frequency converter, for purposes of braking another underwater powerplant, an interruption of the converter feed of the electrical generator occurs, as a result of which its ancillary torque at least partly ceases to exist.

17. The method in accordance with claim 14, characterised in that for those underwater powerplants, which provide a second frequency converter, or a component of a second frequency converter, for purposes of braking another underwater powerplant, an interruption of the converter feed of the electrical generator occurs, as a result of which its ancillary torque at least partly ceases to exist.

18. The method in accordance with claim 15, characterised in that for those underwater powerplants, which provide a second frequency converter, or a component of a second frequency converter, for purposes of braking another underwater powerplant, an interruption of the converter feed of the electrical generator occurs, as a result of which its ancillary torque at least partly ceases to exist.

19. The method in accordance with claim 16, characterised in that those underwater powerplants, whose frequency converters, or whose components of the frequency converter, are used for purposes of executing a braking operation on another underwater powerplant of the energy park, are fitted with a water turbine that is designed to operate reliably at high running speeds, at least up to the runaway rotational speed.

20. The method in accordance with claim 17, characterised in that those underwater powerplants, whose frequency converters, or whose components of the frequency converter, are used for purposes of executing a braking operation on another underwater powerplant of the energy park, are fitted with a water turbine that is designed to operate reliably at high running speeds, at least up to the runaway rotational speed.

21. The method in accordance with claim 18, characterised in that those underwater powerplants, whose frequency converters, or whose components of the frequency converter, are used for purposes of executing a braking operation on another underwater powerplant of the energy park, are fitted with a water turbine that is designed to operate reliably at high running speeds, at least up to the runaway rotational speed.

22. The method in accordance with claim 10, characterised in that the second frequency converter, or the component of the second frequency converter, is a separate frequency converter, which is not used in normal operation.

23. The method in accordance with claim 11, characterised in that the second frequency converter, or the component of the second frequency converter, is a separate frequency converter, which is not used in normal operation.

24. The method in accordance with claim 12, characterised in that the second frequency converter, or the component of the second frequency converter, is a separate frequency converter, which is not used in normal operation.

25. The method in accordance with claim 13, characterised in that the second frequency converter, or the component of the second frequency converter, is a separate frequency converter, which is not used in normal operation.

26. The method in accordance with claim 16, characterised in that the second frequency converter, or the component of the second frequency converter, is a separate frequency converter, which is not used in normal operation.

27. The method in accordance with claim 19, characterised in that the second frequency converter, or the component of the second frequency converter, is a separate frequency converter, which is not used in normal operation.

28. The method in accordance with claim 22, characterised in that the underwater powerplant is part of an energy park, and additionally or alternatively at least one other second frequency converter, or one other component of a second frequency converter, is connected into the circuit with the separate frequency converter for purposes of executing the braking operation of another underwater powerplant of the energy park.

29. An underwater powerplant comprising:
a water turbine for purposes of absorbing kinetic energy from a flow of water;
an electrical generator, whose generator rotor is connected in a torsionally rigid manner with the water turbine;
a converter feed for the electrical generator with a first frequency converter;
characterised in that,
the underwater powerplant comprises a coupling device, which during the braking operation synchronises at least one second frequency converter, or one component of a second frequency converter, with the first frequency converter, and connects into the circuit of the converter feed to the electrical generator in order to generate, jointly with the first frequency converter, a generator torque braking the water turbine.
